(19) United States
(12) Patent Application Publication
(10) Pub. No.: US 2015/0333348 A1
(43) Pub. Date: Nov. 19, 2015

(54) METHOD AND APPARATUS FOR ADJUSTING OXYGEN PRESSURE OF FUEL CELL SYSTEM

(71) Applicant: Hyundai Motor Company, Seoul (KR)

(72) Inventors: Jung-Yeon Byun, Seoul (KR); Sung Bum Choi, Seongnam (KR); Jong Hyun Lee, Yongin-si (KR)

(21) Appl. No.: 14/561,267

(22) Filed: Dec. 5, 2014

(30) Foreign Application Priority Data
May 19, 2014 (KR) 10-2014-0059678

(51) Int. Cl. H01M 8/04; H01M 8/24

(52) U.S. Cl. CPC H01M 8/04104; H01M 8/04298; H01M 8/24; H01M 2250/20

(57) ABSTRACT

Disclosed are a method and an apparatus for adjusting a partial pressure of oxygen that is supplied to a fuel cell system. The oxygen partial pressure may be adjusted by primarily increasing an SR of air and by secondarily increasing a closing ratio of an opening and closing valve when a concentration of oxygen in the air is detected to be reduced. The oxygen partial pressure adjusting device of a fuel cell system includes: an air supply; a fuel supply; an oxygen sensor that is installed in an air supply line and detect a concentration of oxygen; an opening and closing valve and adjust an air supply pressure; and a controller that adjusts a partial pressure of oxygen using the opening and closing valve and a concentration of oxygen that is detected by the oxygen sensor.

### CROSS-REFERENCE TO RELATED APPLICATION

This application claims priority to and the benefit of Korean Patent Application No. 10-2014-0059678 filed in the Korean Intellectual Property Office on May 19, 2014, the entire contents of which are incorporated herein by reference.

### TECHNICAL FIELD

The present invention relates to a method and apparatus for adjusting an oxygen partial pressure of a fuel cell system. In particular, the partial pressure of oxygen that is supplied to a fuel cell system may be adjusted by primarily increasing a stoichiometry ratio of air and by secondarily increasing a closing ratio of an opening and closing valve when a concentration of oxygen is determined to be reduced in the air.

### BACKGROUND

A fuel cell system generates electricity or electrical energy by directly converting chemical energy of fuel into electrical energy.

The fuel cell system includes a fuel cell stack that generates electrical energy, a fuel supply device that supplies fuel (hydrogen) to the fuel cell stack, an air supply device that supplies oxygen of air as an oxidizing agent necessary for an electrochemical reaction to the fuel cell stack, and a heat and water management device that removes reaction heat of the fuel cell stack to the outside of the system and that controls a driving temperature of the fuel cell stack.

The fuel cell system generates electricity and exhausts heat and water of reaction by-products formed during an electrochemical reaction of hydrogen and oxygen of air.

In a fuel cell stack that is applied to a fuel cell vehicle, unit cells are continuously arranged, and at the innermost of each unit cell, a Membrane-Electrode Assembly (MEA) is located. The MEA is formed with an electrolyte membrane where protons can move, and a catalyst layer such as a cathode and an anode which is coated for reaction of hydrogen and oxygen at each surface of the electrolyte membrane.

Further, in an outer portion of the MEA where the cathode and the anode are located, a Gas Diffusion Layer (GDL) is located. At the outside of the gas diffusion layer, a separator is located in which a flow field is formed to supply fuel and air to the cathode and the anode and to exhaust water that is generated by a reaction.

Accordingly, when hydrogen and oxygen are ionized with a chemical reaction by each catalyst layer, an oxidation reaction occurs in which protons and electrons are generated at the anode, and as oxygen ions react with protons, a reduction reaction occurs in which water is generated at the cathode. As an electrode catalyst used in a fuel cell, a catalyst including a platinum catalyst and a promotor metal such as Ru, Co and Cu in a catalyst support that is formed with a carbon material is generally used.

In the fuel cell system, hydrogen is supplied to an anode (also referred to as an “oxidation electrode”), and oxygen (air) is supplied to a cathode (also referred to as a “reduction electrode”). Hydrogen that is supplied to the anode is decomposed into protons (H⁺) and electrons (e⁻) by the catalyst of the anode that is formed at the anode side of the electrolyte membrane. Among them, only protons (H⁺) selectively pass through the electrolyte membrane via a positive ion exchange membrane and are transferred to the cathode. Simultaneously, electrons (e⁻) are transferred to the cathode through conductive separator and the gas diffusion layer (GDL).

In the cathode, protons that are supplied through the electrolyte membrane and electrons that are transferred through the separator react with oxygen of the air that is supplied to the cathode by an air supply device to cause a reaction that generates water.

By movement of protons occurring at this time, a current is generated with flow of electrons through an external conductive wire. During water generation reaction, heat incidentally occurs.

Because hydrogen that is supplied to the anode is injected into a tank system, an amount of supplied hydrogen may be almost constantly maintained, but because oxygen is absorbed from the air of the atmosphere and used, oxygen may not always maintain a predetermined concentration. For example, when driving of a vehicle is performed at a location at which air ventilation is not sufficient, the concentration of oxygen may be reduced. When air having a reduced concentration of oxygen is supplied to a fuel cell system, output may deteriorate due to reduced oxygen partial pressure below a normal state within a fuel cell stack.

In the related arts, a variable pressure system that differentially adjusts a supply pressure of air according to an output occurring in a fuel cell system has been used, but reduced concentration of oxygen may not be improved flexibly.

The above information disclosed in this Background section is only for enhancement of understanding of the background of the invention and therefore it may contain information that does not form the prior art that is already known in this country to a person of ordinary skill in the art.

### SUMMARY OF THE INVENTION

In a preferred aspect, the present invention can address one or more of the method and the apparatus having advantages of adjusting a partial pressure of oxygen that is supplied to a fuel cell system. The oxygen partial pressure may be adjusted by primarily increasing a stoichiometry ratio (SR) of air and by secondarily increasing a closing ratio of an opening and closing valve when a reduced concentration of oxygen in the air is detected.

In an exemplary embodiment, oxygen partial pressure adjusting device of a fuel cell system is provided. The device may include: an air supply configured to supply or exhaust air; a fuel supply configured to supply or exhaust a fuel gas; a fuel cell stack configured to generate electricity using the air and the fuel gas that are supplied from the air supply and the fuel supply; an oxygen sensor configured to be installed in an air supply line that connects the air supply and the fuel cell stack to detect a concentration of oxygen; an opening and closing valve configured to be installed in an air manifold that exhausts air in the air supply to adjust an air supply pressure; and a controller configured to adjust a partial pressure of oxygen using the opening and closing valve and a concentration of oxygen that is detected by the oxygen sensor.

The oxygen sensor may include an air pollution sensor.

The controller may increase a stoichiometry ratio (SR) of air, when a concentration of oxygen detected by the oxygen sensor is less than a predetermined concentration, and the controller may increase an air SR and then increase a closing ratio of the opening and closing valve, when a voltage of an applied current of the fuel cell stack is less than a reference voltage for fuel cell output.

The oxygen partial pressure adjusting device of the fuel cell system may further include a display unit configured to provide guidance to a driver. Particularly, the display unit may display a warning to a driver when a reference voltage for a fuel cell output is less than a predetermined voltage even after the controller increases the closing ratio of the opening and closing valve.

In an exemplary embodiment, a method of adjusting an oxygen partial pressure of a fuel cell system is also provided. The method may include: detecting an oxygen concentration of air that is supplied from an air supply to a fuel cell stack; increasing a stoichiometry ratio (SR) of air when the detected concentration of oxygen is less than a predetermined concentration; and raising a closing ratio of an opening and closing valve after the air SR is raised when a voltage of an applied current of the fuel cell stack is less than a reference voltage for fuel cell output.

The method may further include displaying a warning to a driver through a display unit after a closing ratio of the opening and closing valve is increased, when a voltage of an applied current of the fuel cell stack is less than a reference voltage for fuel cell output.

Also provided are vehicles that comprise the device of the invention to adjust an oxygen partial pressure of a fuel cell system. Further provided are vehicles that use the method of the invention to adjust an oxygen partial pressure of a fuel cell system thereof.

As described above, according to various exemplary embodiment of the present invention, although a concentration of oxygen is changed according to a driving environment, a partial pressure of oxygen that is supplied to a fuel cell system may be constantly maintained, output of the fuel cell system may be prevented from being deteriorated.

### BRIEF DESCRIPTION OF THE DRAWINGS

FIG. 1 illustrates an exemplary oxygen partial pressure adjusting device of a fuel cell system according to an exemplary embodiment of the present invention.

FIG. 2 illustrates an exemplary method of adjusting an oxygen partial pressure of a fuel cell system according to an exemplary embodiment of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention.

In the entire specification, unless explicitly described to the contrary, the word “comprise” and variations such as “comprises” or “comprising” will be understood to imply the inclusion of stated elements but not the exclusion of any other elements.

Like reference numerals designate like elements throughout the specification.

An exemplary embodiment of the present invention will hereinafter be described in detail with reference to the accompanying drawings.

An oxygen partial pressure adjusting device of a fuel cell system according to an exemplary embodiment of the present invention is provided in a fuel cell vehicle where the fuel cell system generates electrical energy by an electrochemical reaction of fuel and an oxidizing agent.

When a fuel cell system is formed with a direct oxidation fuel cell method, a fuel may include an alcohol liquid fuel such as methanol and ethanol, and may further include a hydrocarbon-based liquefied gas fuel using methane, ethane, propane, or butane as a main component.

When a fuel cell system is formed with a polymer electrolyte membrane fuel cell method, the fuel may include a reforming gas with a hydrogen component that is generated from the liquified gas fuel or the liquid fuel through a reforming device that is referred to as a “reformer” in the art. In the present specification, for convenience, the fuel is referred to as hydrogen.

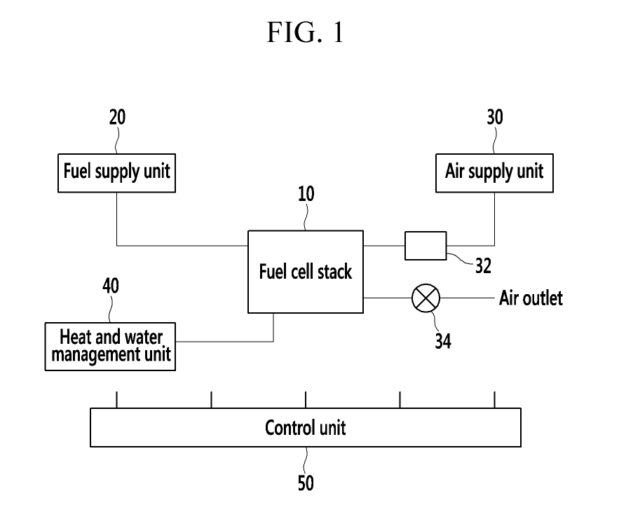

FIG. 1 illustrates an exemplary oxygen partial pressure adjusting device of a fuel cell system according to an exemplary embodiment of the present invention.

As shown in FIG. 1, an oxygen partial pressure adjusting device of a fuel cell system may include: a fuel cell stack 10 that generates electrical energy; a fuel supply 20 that supplies hydrogen as a fuel of the fuel cell stack 10; an air supply 30 that supplies air necessary for an electrochemical reaction to the fuel cell stack 10; an oxygen sensor 32 that is installed in an air supply line that connects the air supply 30 and the fuel cell stack 10 and detects a concentration of oxygen; an opening and closing valve 34 that is installed in an air manifold that exhausts air in the air supply 30 and adjust an air supply pressure; a heat and water management unit 40 that removes reaction heat of the fuel cell stack 10 to the outside of the system, controls a driving temperature of the fuel cell stack 10, and performs a water management function; and a controller 50 that controls an entire operation of the fuel cell system.

The fuel supply 20 may include a hydrogen tank, a proportional control valve, and a hydrogen recirculation unit, and the air supply 30 may include an air blower and a humidifier.

High pressure hydrogen that is supplied from the hydrogen tank of the fuel supply 20 may be supplied to the fuel cell stack 10 with a lower pressure via a proportional control valve, and in the hydrogen recirculation unit, hydrogen may be reused by installing a recirculation blower in a recirculation line, and by recirculating remaining non-reacted hydrogen to an anode and a cathode after using it in an anode of the stack.

The oxygen sensor 32 may be installed in an air supply line that connects the air supply 30 and the fuel cell stack 10. The oxygen sensor 32 may include an air pollution sensor that measures a flow rate of air and detects a pollution degree according to an oxygen concentration of air.

The oxygen sensor 32 may also detect a concentration of oxygen that is supplied to the fuel cell stack 10 in real time. When a vehicle drives in a closed and sealed space such as indoors or in a tunnel, the controller 50 may include logic that may detect a concentration change, and determine whether a concentration of oxygen injected to the fuel cell system is reduced.

The opening and closing valve 34 may be installed in an air manifold that exhausts air in the air supply 30, and may selectively open and close the air manifold by an electrical control signal. For example, the opening and closing valve 34 may include a solenoid valve.

Further, the opening and closing valve 34 may adjust an opening and closing ratio according to a control signal that is received from the controller 50, thereby adjusting a pressure of air that is supplied to the fuel cell stack 10. For example, the opening and closing valve 34 may be, but not limited to, a Back pressure Control Valve (BCV).

The heat and water management unit 40 may include a coolant pump and a radiator. For injecting coolant that is adjusted to an optimal temperature into the fuel cell stack, the radiator may adjust the temperature of the coolant. Coolant having passed through the radiator may be cooled by heat exchange with external air, and coolant of which the temperature is adjusted may be also supplied to the fuel cell stack 10.

By controlling each constituent element, the controller 50 may control hydrogen and oxygen that are supplied to the anode and the cathode of the fuel cell stack 10, thereby generating electricity. In an exemplary embodiment of the present invention, the controller 50 may adjust a partial pressure of oxygen that is supplied to the fuel cell stack 10 using the opening and closing valve 34 and a concentration of oxygen that is detected by the air pollution sensor 32.

When a concentration of hydrogen that is detected by the oxygen sensor 32 is less than a predetermined concentration, the controller 50 may increase a stoichiometry ratio (SR) of air. An air SR may be an actual supply air amount compared to a theoretical air amount. When the air SR is increased, the actual supply air amount may increase and thus reactivity of the fuel cell stack 10 may be increased.

Further, although the air SR is increased, if driving performance is not restored, the controller 50 may increase a closing ratio of the opening and closing valve 34. As such, the controller 50 may be implemented with at least one processor operating by a predetermined program, and the predetermined program may be programmed to perform each step according to a method of adjusting an oxygen partial pressure of a fuel cell system according to an exemplary embodiment of the present invention.

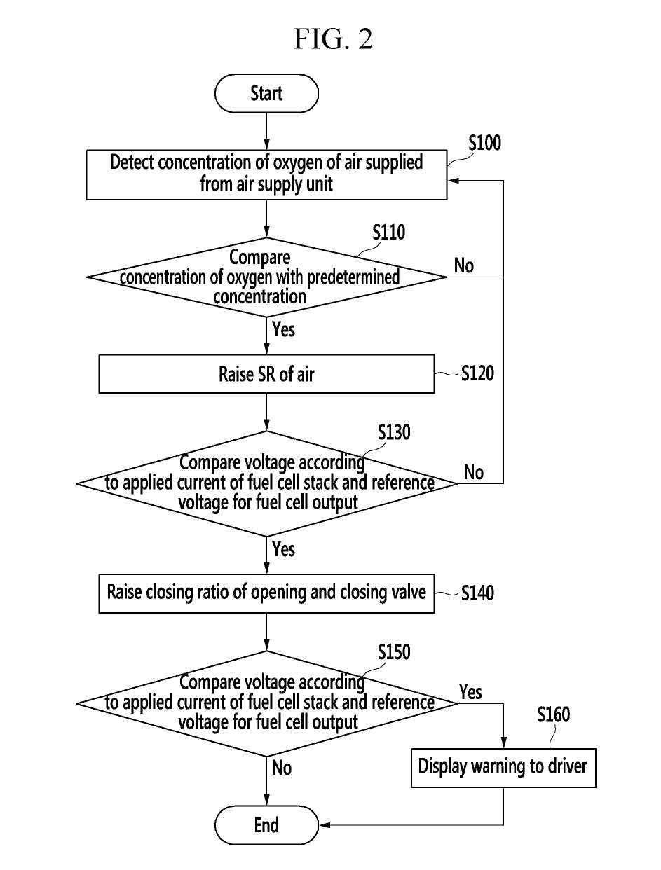

FIG. 2 illustrates an exemplary method of adjusting an oxygen partial pressure of a fuel cell system according to an exemplary embodiment of the present invention.

As shown in FIG. 2, a method of adjusting an oxygen partial pressure of a fuel cell system according to an exemplary embodiment of the present invention may be started as the air pollution sensor 32 detects a concentration of oxygen of air that is supplied from the air supply 30 to the fuel cell stack 10 (S100).

When the air pollution sensor 32 detects a concentration of oxygen of air that is supplied to the fuel cell stack 10, the controller 50 may compare the detected concentration of oxygen with a predetermined concentration (S110) and determine whether the concentration of oxygen is reduced.

If the detected concentration of oxygen is less than a predetermined concentration, which may indicate that sufficient oxygen is not supplied, the controller 50 may increase the stoichiometry ratio SR of air that is supplied to the fuel cell stack 10 (S120).

When the air SR is increased at step S120, the concentration of oxygen may increase, and thus in order to determine whether driving performance of the fuel cell is restored, the controller 50 may compare a voltage according to an applied current of the fuel cell stack and a reference voltage for a predetermined fuel cell output (S130).

When a voltage according to an applied current of the fuel cell stack is less than a reference voltage for a predetermined fuel cell output, the controller 50 may increase the closing ratio of the opening and closing valve 34 (S140) by outputting a control signal.

Although the air SR is increased at step S120, when the driving performance of the fuel cell is not restored, the controller 50 may increase the pressure of air that is supplied to the fuel cell stack 10 by reducing the opening angle of the opening and closing valve 34 at step S140. In other words, the controller 50 may increase the SR of the air, and in addition, by raising the pressure of air by increasing the closing ratio of the opening and closing valve 34, the controller 50 may adjust a partial pressure of oxygen that is supplied to the fuel cell stack 10 with at least two steps.

Subsequently, the controller 50 may compare the voltage again according to the applied current of the fuel cell stack and the reference voltage for the predetermined fuel cell output, and determine whether the performance of the fuel cell is restored by monitoring the voltage (S150).

When the voltage according to the applied current of the fuel cell stack is less than the reference voltage for the predetermined fuel cell output, the display unit displays a warning to the driver (S160).

Accordingly, although the concentration of oxygen is changed according to the driving environment, output of the fuel cell system can be prevented from being deteriorated by constantly maintaining the partial pressure of oxygen that is supplied to the fuel cell system.

While this invention has been described in connection with what is presently considered to be various exemplary embodiments, it is to be understood that the invention is not limited to the disclosed embodiments, but, on the contrary, is intended to cover various modifications and equivalent arrangements included within the spirit and scope of the appended claims.

What is claimed is:

1. An oxygen partial pressure adjusting device of a fuel cell system, comprising:
an air supply configured to supply or exhaust air;
a fuel supply configured to supply or exhaust a fuel gas;
a fuel cell stack configured to generate electricity using the supplied air and the supplied fuel gas;
an oxygen sensor installed in an air supply line that connects the air supply and the fuel cell stack and configured to detect a concentration of oxygen;
an opening and closing valve installed in an air manifold configured to exhaust air in the air supply to adjust an air supply pressure; and
a controller configured to adjust a partial pressure of oxygen using the opening and closing valve and a concentration of oxygen detected by the oxygen sensor.

2. The oxygen partial pressure adjusting device of claim 1, wherein the oxygen sensor includes an air pollution sensor.

3. The oxygen partial pressure adjusting device of claim 1, wherein the controller is configured to increase a stoichiometry ratio (SR) of air, when a concentration of oxygen detected by the oxygen sensor is less than a predetermined concentration.

4. The oxygen partial pressure adjusting device of claim 3, wherein the controller is configured to increase the air SR and then increase a closing ratio of the opening and closing valve when a voltage of an applied current of the fuel cell stack is less than a reference voltage for a fuel cell output.

5. The oxygen partial pressure adjusting device of claim 4, further comprising: a display configured to provide guidance to a driver,
wherein the display configured to display a warning to a driver, when the reference voltage for a fuel cell output is less than a predetermined voltage even after the controller increases the closing ratio of the opening and closing valve.

6. A method of adjusting an oxygen partial pressure of a fuel cell system, comprising:
detecting, by an oxygen sensor, an oxygen concentration of air that is supplied from an air supply to a fuel cell stack;
increasing, by a controller, a stoichiometry ratio (SR) of air when the detected concentration of oxygen is less than a predetermined concentration,; and
increasing, by the controller, a closing ratio of the opening and closing valve, after the air SR is increased, when a voltage of an applied current of the fuel cell stack is less than a reference voltage for a fuel cell output.

7. The method of claim 6, further comprising: displaying, by the controller, a warning to a driver through a display, after a closing ratio of the opening and closing valve is increased, when a voltage by an applied current of the fuel cell stack is less than the reference voltage for a fuel cell output.

8. A vehicle comprising an oxygen partial pressure adjusting device of a fuel cell system of claim 1.

9. A vehicle using a method of claim 6 to adjust an oxygen partial pressure of a fuel cell system thereof.

10. A non-transitory computer readable medium containing program instructions executed by a controller, the computer readable medium comprising:
program instructions that operate an oxygen sensor to detect an oxygen concentration of air that is supplied from an air supply to a fuel cell stack;
program instructions that increase a stoichiometry ratio (SR) of air when the detected concentration of oxygen is less than a predetermined concentration,; and
program instructions that increase a closing ratio of the opening and closing valve, after the air SR is increased, when a voltage of an applied current of the fuel cell stack is less than a reference voltage for a fuel cell output.

11. The non-transitory computer readable medium of claim 10, further comprising:
program instructions that display a warning to a driver through a display, after a closing ratio of the opening and closing valve is increased, when a voltage by an applied current of the fuel cell stack is less than the reference voltage for a fuel cell output.
